(19) United States
(12) Patent Application Publication
(10) Pub. No.: US 2006/0109602 A1
(43) Pub. Date: May 25, 2006

(54) Electrostatic shielding packaging composition and methods for producing and using the same

(76) Inventor: Robert J. Vermillion, Clayton, CA (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 10/997,544

(22) Filed: Nov. 24, 2004

(51) Int. Cl. H02H 1/00; H02H 1/04

(52) U.S. Cl. 361/212

(57) ABSTRACT

The current invention provides improved electrostatic shielding packaging materials. The improved materials comprise paper having a electrostatic shielding layer capable of attenuating high voltage discharges sufficiently to preclude damage to an ESD-sensitive device. The electrostatic shielding layer comprises at least one coat of a conductive material and at least one coat of a protective varnish. The current invention also provides a method for preparing electrostatic shielding packaging materials. The method of the current invention applies the electrostatic shielding layer using a preprint process. Further, the current invention provides a method for protecting ESD-sensitive components from electrostatic discharge. Finally, the current invention also provides electrostatic shielding packaging material having a visually identifiable mark within an electrostatic shielding layer carried by the packaging material and a method for preparing the same.

### BACKGROUND OF THE INVENTION

The current invention relates to improvements in electrostatic shielding packaging materials prepared from paper. The current invention also provides methods for manufacturing the improved electrostatic shielding packaging materials. Finally, the current invention provides methods for safely transporting electrostatic sensitive devices.

Desktop computers, cell phones, television sets and other electrical devices utilize a multitude of electrostatic sensitive components. During assembly, the manufacturer takes extreme care to protect these components from inadvertent electrostatic discharge (ESD). In particular, manufacturers typically identify those areas of assembly where ESD-sensitive devices are handled. These areas require ESD controls and are known as electrostatic protected areas (EPA). One aspect of ESD control relates to the proper packaging of ESD-sensitive devices for transport from one EPA to another EPA.

Electrostatic electricity occurs naturally as a result of friction between two dissimilar materials. For example, movement of electrical components from one assembly area or plant to another creates an opportunity for the generation of electrostatic electricity. More accurately, the movement of an object in relation to another object generates a triboelectric charge on the surface of the objects. Subsequently, an ESD event may occur when a conductive path is established to an electrical ground. A resulting ESD event can significantly damage an ESD-sensitive device. In the ESD Association estimates annual costs due to ESD events to be greater than $4,000,000,000.

Significant progress has been made in developing packaging materials for ESD-sensitive devices. For example, corrugated sheeting having electrostatic shielding and dissipative characteristics is disclosed in U.S. Pat. No. 5,637,377, issued to the inventor of the current invention. Additionally, metallized or metal-in, electrostatic-shielding bags are available from 3M® and other manufacturers. However, corrugated boxes are too bulky or inflexible for some applications and the flexible metallized bags are relatively expensive and do not contain recyclable materials.

Accordingly, a need exists for a paper based, relatively flexible and recyclable, electrostatic shielding packaging material. Preferably, the paper based electrostatic shielding packaging composition will be readily adaptable to various shapes such as bags, envelopes, tubes, and sleeves or available as rolls suitable for wrapping larger ESD-sensitive devices. Further, it would be beneficial if the method for manufacturing the electrostatic shielding packaging material permitted the incorporation of a visually identifiable mark in the electrostatic shielding layer of the packaging material.

### SUMMARY OF THE INVENTION

The current invention provides an electrostatic shielding packaging composition. The composition of the current invention comprises a paper component having a basis weight between about 10 pounds per thousand square feet (10 lbs/MSF) to about 69 pounds per thousand square feet (69 lbs/MSF). One side of the paper component carries an electrostatic shielding layer. The electrostatic shielding layer comprises at least one coat of conductive ink and at least one coat of varnish over the conductive ink. Preferably, the electrostatic shielding layer provides a surface resistance of less than about 1.0×10³ ohms (in compliance with ANSI/ESD S541-2003, Packaging & Materials Standard). Preferably, any voltage penetrating the composition will be attenuated to about 100 volts or less when the initial Human Body Model high voltage discharge is about 3500 volts when measured according to the Dr. Kolyer High Voltage Discharge Test developed about 1984.

In another embodiment, the current invention provides an electrostatic shielding packaging composition. The composition of the current invention comprises a paper component having a basis weight between about 10 pounds per thousand square feet (10 lbs/MSF) to about 69 pounds per thousand square feet (69 lbs/MSF). One side of the paper component carries an electrostatic shielding layer. The electrostatic shielding layer comprises at least one coat of conductive ink and at least one coat of varnish over the conductive ink. Optionally, a coat of water-based ink is applied between the conductive ink and the varnish. The water-based ink coat provides a visually identifiable mark within the electrostatic shielding layer. The electrostatic shielding layer provides a surface resistance of less than about 1.0×10³ ohms. Preferably, the composition will attenuate an ESD event such that energy or charge (where Charge: (Q)=Capacitance (C)×Voltage (V)) penetrating the composition will be about 50 nanoJoules or less when the initial voltage discharge is about 1000 volts per ANSI/ESD STM-2001.

Still further, the current invention provides storage containers having electrostatic shielding characteristics. The storage containers comprise a paper component having a basis weight between about 10 pounds per thousand square feet (10 lbs/MSF) to about 69 pounds per thousand square feet (69 lbs/MSF). One side of the paper component carries an electrostatic shielding layer. The electrostatic shielding layer comprises at least one coat of conductive ink and at least one coat of varnish over the conductive ink. The electrostatic shielding layer provides a surface resistance of less than about 1.0×10³ ohms. Optionally, a coat of water-based ink is applied over at least a portion of the conductive ink. This coat of water based ink provides a visually identifiable mark within the electrostatic shielding layer.

Additionally, the current invention provides a method for protecting ESD-sensitive devices from ESD. According to the method of the current invention, an electrostatic shielding packaging composition is formed by applying an electrostatic shielding layer to one side of a paper component. The paper component has a basis weight between about 10 lbs/MSF to about 69 lbs/MSF. The electrostatic shielding layer comprises at least one coat of conductive ink and at least one coat of varnish over the coat of conductive ink. Following application of the electrostatic shielding layer, the electrostatic shielding packaging composition is placed around the ESD-sensitive device with the electrostatic shielding layer facing the ESD-sensitive device. Alternatively, the paper component carrying the electrostatic shielding layer is formed into a bag, envelope or other similar container with the electrostatic shielding layer to the inside of the container and the ESD-sensitive device placed within the container.

In yet another embodiment, the current invention provides a method forming a visually identifiable mark within the electrostatic shielding layer of an electrostatic shielding packaging composition. The identifying mark has visual characteristics similar to water marks. According to the method of the current invention, a paper component is provided having a basis weight between about 10 lbs/MSF and about 69 lbs/MSF. At least one coat of conductive ink is applied to the first side of the paper component. Subsequently, a coat of water-based ink is applied over at least a portion of the conductive ink. The water-based ink coat provides a visually discernible identifying mark. Finally, at least one coat of varnish is applied over the prior coats of conductive ink and water-based ink.

### BRIEF DESCRIPTION OF THE DRAWINGS

FIG. 1 is a top view of an electrostatic shielding packaging composition of the present invention depicting an identifying mark.

FIG. 2 is a cross-sectional view of the electrostatic shielding packaging composition of the current invention depicting the electrostatic shielding layer.

### DETAILED DISCLOSURE OF THE INVENTION

I. Defined Terms

This disclosure utilizes the following defined terms:

Electrostatic damage. Change in an electrostatic sensitive device caused by an electrostatic discharge. As a result of the electrostatic discharge the device fails to meet one or more specified parameters.

Electrostatic discharge (ESD). The rapid, spontaneous transfer of electrostatic charge usually resulting when two objects of different potentials come into direct contact. However, an ESD event may also be induced when a high electrostatic field develops between two objects in close proximity. The rapid transfer of electrostatic charge between two objects is sometimes referred to as a high voltage discharge. Usually, the charge flows through a spark between two bodies at different electrostatic potentials as they approach one another. Details of such processes, such as the rate of the charge transfer, are described in specific electrostatic discharge models.

ESD Models. There are three (3) predominant ESD models: the Human Body Model (HBM); the Charged Device Model (CDM); and, the Machine Model (MM). The HBM simulates an ESD event which results when a person carrying either a positive or negative potential touches an ESD-sensitive component at another potential. The CDM simulates an ESD event wherein an ESD-sensitive component having a certain potential comes into contact with a conductive surface at a different potential. The MM simulates an ESD event occurring when a tool contacts an ESD-sensitive device at a different potential. HBM and CDM are considered to be more ‘real world’ models than the MM.

Electrostatic discharge protected area (EPA). An area of a manufacturing or shipping facility requiring the use of materials capable of one or more of the following: reducing the generation of electrostatic electricity, dissipating an electrostatic charge, or providing shielding from electrostatic discharge or electrostatic fields.

Electrostatic discharge shield. A barrier or enclosure that limits the passage of current and attenuates an electromagnetic field resulting from an electrostatic discharge. Electrostatic Shielding is defined by ANSI/ESD S541-2003 as having a shielding layer with a surface resistance measuring less than about 1.0×10³ ohms and providing a barrier to current flow to an electrostatic sensitive device.

ESD Protective. A property of materials capable of one or more of the following: preventing the generation of electrostatic electricity; dissipating electrostatic charges over its surface or volume; or, providing shielding from an ESD event or an electrostatic field.

Surface Resistance. The ratio of DC voltage {R=V/I] to the current flowing between two electrodes of specified configuration that contact the same side of a material. This measurement is expressed in ohms per ANSI/ESD STM-2001.

Surface Resistivity. For electric current flowing across a surface, the ratio of DC voltage drop per unit length to the surface current per unit width. In effect, the surface resistivity is the resistance between two opposite sides of a square and is independent of the size of the square or its dimensional units. Surface resistivity is expressed in ohms/square per ASTM D257-99.

II. ESD Protective Packaging Materials

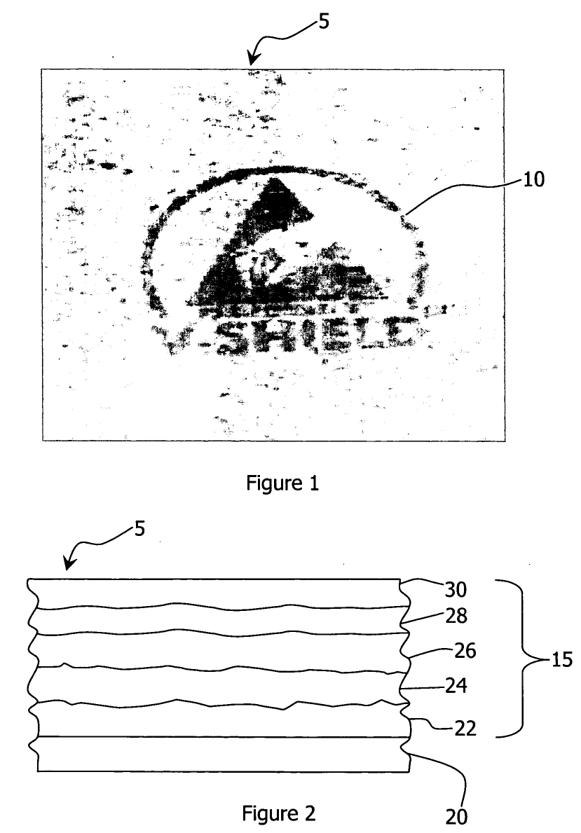

In one aspect, the current invention provides improved packaging materials for ESD-sensitive devices. The improved packaging materials provide sufficient attenuation of electrostatic fields to preclude damage to ESD devices housed within or wrapped by the electrostatic shielding packaging material from high voltage discharges. As shown in FIG. 1, a particularly preferred embodiment of the improved electrostatic shielding packaging composition 5 has a visually identifiable mark 10, also referred to herein as identifying mark 10, within the electrostatic shielding layer 15 carried by electrostatic shielding packaging composition 5. Identifying mark 10 is similar in appearance to watermarks commonly found on quality stationary and printed currency. Identifying mark 10 may have virtually any design and is suitable for depicting lot numbers, symbols, and other identifying characteristics on electrostatic shielding packaging composition 5. For example, the ESD association has prepared an electrostatic discharge protective symbol suitable for identifying ESD shielding materials, this symbol could easily be incorporated on electrostatic shielding packaging composition 5 of the current invention. Manufacturers may also elect to use identifying mark 10 to indicate lot numbers, shipping dates, and other elements that would identify the items contained within the packaging material.

The electrostatic shielding packaging materials of the current invention may be provided in one of several different configurations. For example, electrostatic shielding packaging composition 5 of the current invention may be a spool of paper suitable for wrapping around an ESD-sensitive device. Alternatively, electrostatic shielding packaging composition 5 of the current invention is readily adaptable for forming paper bags, paper tubes, or envelopes of various sizes and configurations suitable for housing ESD-sensitive devices. Thus, electrostatic shielding packaging composition 5 of the current invention can be adapted to various geometric shapes, configurations, and sizes necessary to enclose or cover the ESD-sensitive device.

Electrostatic shielding packaging composition 5 comprises a single layer of paper component 20. Paper component 20 may be a single ply of paper or may be formed of multiple plies of paper. Preferably, paper component 20 is Kraft paper having a basis weight of about 10 pounds per thousand square feet (10 lbs/MSF) to about 69 pounds per thousand square feet (69 lbs/MSF). The preferred Kraft paper is a “high performance paper” suitable for forming into a paper bag, envelope or tube.

As used herein, the term “high performance paper” refers to a paper in which the fiber materials are generally aligned throughout the paper composition. This type of paper is generally prepared on a Fourdrinier machine. Further, preferred paper component 20 will have a characteristic referred to as “high holdout”. As used herein the term “high holdout paper” refers to a paper composition which has been calendared sufficiently to yield a surface that is extremely smooth and generally non-porous. As such, the paper does not readily absorb ink or other aqueous materials. A preferred high performance, high holdout paper component 20 for use in the current invention will typically have a bursting strength of about 87 pounds per square inch to about 129 pounds per square inch when measured according to TAPPI T-807.

Electrostatic shielding packaging composition 5 of the present invention carries an electrostatic shielding layer 15 on paper component 20. In a preferred embodiment, electrostatic shielding layer 15 comprises at least two coats of conductive ink 22, 24, at least one coat of water-based ink 26, and at least one coat of varnish 28. The two coats of conductive ink 22, 24 are adjacent to the paper component 20 of the electrostatic shielding packaging material 5. Over the two coats of conductive ink 22, 24 is optionally at least one coat of water-based ink 26. The coat of varnish 28 provides a protective layer for water-based ink 26 and conductive ink layers 22, 24. More preferably, two coats of varnish 28, 30 are present. Finally, in a preferred embodiment, the coat of water-based ink 26 provides visually identifiable mark 10 as shown in FIG. 1.

Electrostatic shielding packaging material 5 of the current invention attenuates the resulting discharge associated with ESD events. In order to provide the electrostatic shielding properties, electrostatic shielding layer 15 has a surface resistance of less than about 1.0×10³ ohms. More preferably, electrostatic shielding layer 15 provides a surface resistance of less than about 5.0×10² ohms and even more preferably the surface resistance is less than about 4.1×10² ohms. Surface resistance readings are per ANSI/ESD S541-2003, Packaging & Materials Standard.

When subjected to an ESD event, for example a HBM ESD event, the current invention attenuates the resulting discharge sufficiently to avoid damage to an ESD-sensitive device housed within the electrostatic shielding packaging material 5. Specifically, electrostatic shielding packaging material 5 of the current invention will attenuate a voltage discharge from about 3,500 volts down to a charge of about 100 volts or less.

Further, electrostatic shielding packaging material 5 of the current invention will attenuate an ESD event such that energy or charge [where Charge: (Q)=Capacitance (C)×Voltage (V)] penetrating electrostatic shielding packaging material 5 will be about 50 nanoJoules or less when the initial voltage discharge is about 1000 volts per ANSI/ESD STM-2001. Preferably, electrostatic shielding packaging material 5 will provide this ESD protection even under conditions of low relative humidity. For example, electrostatic shielding packaging material 5 of the current invention will attenuate a 1,000 volt charge down to about 50 nanoJoules or less under ESD Association standard conditions of about 12% relative humidity. Further, when subjected to 1,000 volts of ESD discharge, electrostatic shielding packaging material 5 has demonstrated capabilities of reducing the voltage charge to about 100 volts and lower. Thus, a 100 volt electrostatic sensitive device shielded by electrostatic shielding packaging material 5 will not experience electrostatic damage when subjected to 1000 volt discharge.

The conductive ink of the current invention can be any water-based ink suitable for use in printing processes. The water-based ink of conductive layers 22, 24 preferably contains from 12% to 30% by weight of a conductive material selected from the group consisting of carbon black, graphite and conductive polymers. Conductive polymers suitable for use in the current invention include but are not limited to diacetone acrylamide diallydimethylammonium chloride copolymer, polyethylene glycol, diethanol amide, polypyrroles, BAYTRON® P type polymers, available from H. C. Stark, and mixtures thereof. BAYTRON® P type polymers are aqueous conductive polymer dispersions of the conductive polymer PEDT/PSS, poly(3,4-ethylenedioxythiophene)-poly(styrenesulfonate). In a preferred embodiment, the total amount of conductive material present on paper component 20 is between about 0.5 and about 3.5 pounds per 1000 square feet. When using a high hold out, high performance Kraft paperboard as paper component 20, the preferred amount of conductive material will be between about 0.5 and about 2.0 pounds per 1000 square feet. As noted above different paper and paperboard stock absorbs differing amounts of pigment; therefore, the quantity of conductive material necessary to produce the desired surface resistance will vary with the quality of the paper and paperboard stock.

The water-based ink used to apply identifying mark 10 can be any water-based ink suitable for use in printing processes. Finally, any varnish suitable for use in a printing process will be suitable for use in the current invention.

III. Method for Preparing ESD Shielding Packaging Materials

In another aspect, the current invention provides a method for preparing electrostatic shielding packaging material 5. The method of the current invention utilizes paper stock having high holdout and high performance characteristics. The terms “high holdout” and “high performance” have the meanings described above. A preferred embodiment of the current invention will be described with reference to FIGS. 1 and 2.

Preferably, paper component 20 used in the current method will be provided on large rolls of paper. A typical roll of raw paperboard may have a length of about 15,000-21,000 linear feet and widths ranging from about 30 inches to about 160 inches. Paper rolls of this size are commonly available and well known to those skilled in the art of paper manufacturing. The preferred paper stock suitable for use in the current invention will have a basis weight of about 10 lbs/MSF to about 69 lbs/MSF. Preferably, the paper stock is unbleached Kraft paperboard having a basis weight ranging from about 26 lbs/MSF to about 30 lbs/MSF. Paper stock with this basis weight will be sufficiently flexible to permit the formation of electrostatic shielding packaging material 5 into bags, envelopes, rolled tubes and other shapes while at the same time providing sufficient crush strength to protect materials housed therein.

Various printing processes such as preprinting, line screening, gravure printing and off-set printing are suitable for practicing the current invention. However, the preferred method of the current invention utilizes a preprinting process to apply electrostatic shielding layer 15 to paper component 20. The preprinting process permits the application of all components of electrostatic shielding layer 15 in one pass of paper component 20 through the printing machine (not shown). The preprinting process applies each coat of ink or varnish to paper component 20 in the form of dots. Those skilled in the art refer to the application of each coat as a “bump” of ink or varnish. Typically, the preprinting process is capable of applying from about 6400 dots per square inch (80 line screen) to about 22,500 dots per square inch (150 line screen). In the method of the current invention, the preferred process applies conductive ink coat 22 and optional conductive ink coat 24 using a line screen of about 80 (6400 dots/square inch) to about 300 (90,000 dots/square inch). More preferably, coats of conductive ink 22, 24 are applied at a line screen rate of about 100 to about 130.

Thus, in one method of the current invention, paper component 20 is fed into the preprinting machine. As described above, a preferred electrostatic shielding layer 15 comprises five layers. A preferred electrostatic shielding layer 15 is applied as two coats of conductive ink 22, 24 followed by a coat of water-based ink 26 and two subsequent coats of varnish 28, 30. Thus, in the preferred embodiment, the preprinting device used for the practice of the current invention will have at least five stations active during the application of electrostatic shielding layer 15 to paper component 20.

The conductive ink of the current invention can be any water-based ink suitable for use in preprinting processes. The water-based ink used to apply conductive layers 22, 24 preferably contains from 12% to 30% of a conductive material selected from the group of carbon black, graphite and conductive polymers. Conductive polymers suitable for use in the current invention include but are not limited to diacetone acrylamide diallydimethylammonium chloride copolymer, polyethylene glycol, diethanol amide, polypyrroles, BAYTRON® P type polymers, available from H. C. Stark, and mixtures thereof. BAYTRON® P type polymers are aqueous conductive polymer dispersions of the conductive polymer PEDT/PSS, poly(3,4-ethylenedioxythiophene)-poly(styrenesulfonate).

The water-based ink used to apply identifying mark 10 can be any water-based ink suitable for use in printing processes. Finally, any varnish suitable for use in a printing process will be suitable for use in the current invention.

In the preferred embodiment, paper component 20 enters the preprinting device and the first station applies at least one coat of conductive ink 22. Preferably, two coats of conductive ink 22, 24 are applied to paper component 20. Thus, the first two stations within the preprinting process apply coats of conductive ink 22, 24 to the surface of the paper component 20. The amount of conductive material deposited on paper component 20 is sufficient to yield a surface resistance of less than about 1.0×10³ ohms. Depending on the hold out characteristics of paper component 20, from about 0.5 to about 3.5 pounds of conductive material per 1000 square foot of paper will normally produce the desired surface resistance. For a high hold paper, preferably about 0.5 to about 2.0 pounds of conductive material per 1000 square feet will be deposited.

In the preferred embodiment, identifying mark 10 is provided by a subsequent station within the preprinting process applying coat of water-based ink 26 over conductive ink coat 22 or coats 22, 24. Identifying mark 10 is formed using a line screen of about 50 (2500 dots/square inch) to about 85 (7250 dots/square inch). Coat of water based ink 26 forming identifying mark 10 may be a continuous coat of ink substantially completely covering coat or coats of conductive ink 22, 24. Alternatively, coat of aqueous ink 26 forming identifying mark 10 may be limited to the area necessary to form identifying mark 10. Identifying mark 10 may be continuously repeated across electrostatic shielding packaging material 5.

Following the application of coats of conductive ink 22, 24 and coat of water-based ink 26, paper component 20 continues through the preprinting machine. Subsequent stations in the preprinting machine apply at least one coat of varnish 28 over the earlier coats of conductive ink 22, 24 and coat of water-based ink 26. Varnish coat 28 protect against the rub off of the earlier applied coats. The final electrostatic shielding packaging composition 5 is suitable for forming into ESD protective containers such as bags, tubes or other similar containers (not shown).

IV. Method for Protecting ESD-Sensitive Components from Electrostatic Discharge

This method of the current invention utilizes electrostatic shielding packaging composition 5 of the type described above to protect ESD-sensitive components from ESD events during the movement of the components from one EPA to another. According to the method of the current invention, electrostatic shielding packaging composition 5 is prepared according to the process described in the previous section. Thus, electrostatic shielding layer 15 is applied to paper component 20 such that electrostatic shielding packaging composition 5 has a conductive surface with a resistance less than about 1.0×10³ ohms. Electrostatic shielding layer 15 is preferably applied to paper component 20 using the preprinting process described above. Paper component 20 suitable for use in this particular embodiment of the current invention is preferably an unbleached Kraft paper having a basis weight ranging from about 10 lbs/MSF to about 69 lbs/MSF. Preferably, the paper component has a basis weight ranging from about 26 lbs/MSF to about 36 lbs/MSF.

One common problem encountered during the movement of ESD-sensitive devices is the need to secure the devices to a pallet. The industry would prefer to use readily available nylon straps to secure the devices; however, as these straps move back and forth over the ESD-sensitive devices, triboelectric charges develop. When the nylon straps are released, either by cutting or tearing, an ESD discharge through field induction frequently occurs. These discharges can reach levels of about 1000 volts to about 8000 volts or in excess of 50 nanoJoules of energy within the packaging container. Therefore, efforts have been made to provide packaging materials which do not require nylon straps as securing devices. Unfortunately, use of these materials increase the cost of shipping.

The current invention overcomes these problems by providing a method which permits the use of nylon straps and other similar devices while at the same time shielding ESD-sensitive components from an ESD event. In the method of the current invention, electrostatic shielding packaging composition 5 is wrapped around ESD-sensitive devices (not shown) with electrostatic shielding layer 15 adjacent to the EDS-sensitive devices. Following placement of electrostatic shielding packaging composition 5 around the ESD-sensitive devices, nylon strapping can be placed around the exterior of the resulting bundle. Following shipment, the strapping can be removed in a normal manner without risk of damage to the ESD-sensitive devices. Even in the event of an ESD event, electrostatic shielding packaging composition 5 will sufficiently attenuate any resulting high voltage discharge to preclude damage to the ESD-sensitive component. Thus, by wrapping electrostatic shielding packaging composition 5 around trays or stacks of ESD-sensitive devices, the current invention provides a method for protecting ESD-sensitive components from ESD events during shipment of the components and removal of the packaging material from the components following shipment thereof.

In an alternate embodiment of the current invention, electrostatic shielding packaging composition 5 is formed into ESD protective containers such as bags, tubes or other similar containers (not shown). Prior to shipping, the ESD-sensitive devices are simply placed within the paper bags with the open ends folded over in order to preclude an ESD event from reaching the electrostatic sensitive devices. Thus, the current invention also provides for forming of electrostatic shielding packaging composition 5 into a container such as an envelope, a rolled tube, a sleeve or any other flexible embodiment suitable for housing ESD-sensitive components.

For example, JEDEC trays are commonly used to house ESD-sensitive devices. JEDEC trays can have a variety of dimensions depending on the number of components to be placed in the package or requirement of “pick and place” feeding devices for a circuit card assembly device. One typical size would be 11″×4.5″×0.25″ prepared in a configuration that is stackable. Following loading of the JEDEC trays with the ESD-sensitive devices, electrostatic shielding packaging composition 5 of the current invention in the form of a tube, a bag or a simple wrap is placed around the JEDEC trays with electrostatic shielding layer 15 facing the ESD-sensitive devices. When a wrap is used around the JEDEC trays, then electrostatic charge generating devices such as nylon straps and other similar supporting devices may be used to provide structural rigidity. Prior to the current invention, use of such charge generators would be avoided as removing the strap created the likelihood of an ESD event capable of damaging the ESD-sensitive devices. However, in the method of the current invention, shipping time for JEDEC trays housing ESD-sensitive devices can be reduced by rapidly loading the trays, stacking them, wrapping electrostatic shielding packaging composition 5 around the stack of trays and then securing the stack with a nylon strap. When the materials reach their final destination, the strap can be removed without concern of damage due to an ESD event.

Alternatively, stacks of JEDEC trays can be placed within a bag or tube prepared from electrostatic shielding packaging composition 5 of the current invention. Preferably, the tube or bag will have sufficient material at the open end thereof to permit folding over of the open end thereby completely enclosing the JEDEC trays. The ESD-sensitive devices therein can then be shipped from one location to another with a reduced likelihood of damage due to an ESD event.

Thus, the current invention provides an improved method for protecting ESD-sensitive components from ESD events when shipping such components from one location to another. Further, the current invention provides improved paper compositions having electrostatic shielding properties which can be used to shield ESD-sensitive devices. The electrostatic shielding packaging compositions of the current invention may be formed into storage containers such as envelopes, bags, sleeves or wraps. Finally, the present invention also provides a method for preparing paper compositions which are useful as electrostatic shielding packaging compositions.

Other embodiments of the current invention will be apparent to those skilled in the art from a consideration of this specification, the drawings or practice of the invention disclosed herein. However, the foregoing specification is considered merely exemplary of the current invention with the true scope and spirit of the invention being indicated by the following claims.

I claim:

1. An electrostatic shielding packaging composition comprising:
a paper component having a basis weight of about 10 lbs/MSF to about 69 lbs/MSF; and,
an electrostatic shielding layer on said paper component said electrostatic shielding layer comprising at least one coat of conductive ink and at least one coat of varnish.

2. The composition of claim 1, wherein said electrostatic shielding layer further comprises at least one coat of a water-based ink, said water-based ink providing a visually identifiable mark within said electrostatic shielding layer.

3. The composition of claim 1, wherein said composition has a surface resistance of less than about 1.0×10³ ohms.

4. The composition of claim 1, wherein said composition has a surface resistance of less than about 5.0×10² ohms.

5. The composition of claim 1, wherein said composition has a surface resistance of less than about 4.1×10² ohms.

6. The composition of claim 1, wherein resulting voltage penetration of said composition is about 100 volts or less when said composition is subjected to an ESD of about 3,500 volts.

7. The composition of claim 1, wherein resulting energy penetration of said composition is about 50 nanoJoules or less when said composition is subjected to an ESD event of about 1000 volts.

8. The composition of claim 1, wherein resulting voltage penetration of said composition is about 100 volts or less when said composition is subjected to an ESD event of about 1000 volts.

9. The composition of claim 1, wherein resulting voltage penetration of said composition is about 50 volts or less when said composition is subjected to an ESD event of about 1000 volts.

10. The composition of claim 1, wherein resulting energy penetration of said composition is about 50 nanoJoules or less when said composition is subjected to a voltage discharge of about 1000 volts under conditions of about 12% relative humidity.

11. The composition of claim 1, wherein the conductive ink is a water-based ink comprising a conductive material selected from the group consisting of carbon black, graphite and conductive polymers.

12. The composition of claim 1, wherein the paper component has a basis weight of from about 26 lbs/MSF to about 36 lbs/MSF.

13. The composition of claim 1, wherein said electrostatic shielding layer comprises a conductive material in an amount ranging from about 0.5 lbs per MSF of said paper component to about 3.5 lbs per MSF of said paper component said conductive material being selected from the group consisting of carbon black, graphite and conductive polymers.

14. An electrostatic shielding packaging composition comprising:
a paper component having a basis weight between about 26 lbs/MSF and about 36 lbs/MSF;
an electrostatic shielding layer on said paper component;
said composition has a surface resistance of less than about 1.0×10³ ohms;
said electrostatic shielding layer comprising at least one coat of conductive ink and at least one coat of varnish; and
wherein resulting voltage penetration through said composition is about 100 volts or less when said composition is subjected to a voltage discharge of about 3,500 volts.

15. The composition of claim 14, wherein the conductive ink is a water-based ink comprising a conductive material selected from the group consisting of carbon black, graphite, diacetone acrylamide diallydimethylammonium chloride copolymer, polyethylene glycol, diethanol amide, polypyrroles, and poly(3,4-ethylenedioxythiophene)-poly(styrenesulfonate).

16. The composition of claim 14, wherein said electrostatic shielding layer comprises a conductive material in an amount ranging from about 0.5 lbs per MSF of said paper component to about 3.5 lbs per MSF of said paper component said conductive material being selected from the group consisting of carbon black, graphite and conductive polymers.

17. An electrostatic shielding packaging composition comprising:
a paper component having a basis weight between about 10 lbs/MSF and about 69 lbs/MSF;
an electrostatic shielding layer deposited on said paper component;
said composition has a surface resistance of less than about 1.0×10³ ohms;
said electrostatic shielding layer comprising at least one coat of conductive ink, wherein said electrostatic shielding layer comprises a conductive material in an amount ranging from about 0.5 lbs per MSF of said paper component to about 3.5 lbs per MSF of said paper component said conductive material being selected from the group consisting of carbon black, graphite and conductive polymers;
at least one additional coat of ink providing a visually identifiable mark within the electrostatic shielding layer; and,
at least one coat of varnish.

18. The composition of claim 17, wherein said paper component has a basis weight between about 26 lbs/MSF and about 36 lbs/MSF.

19. The composition of claim 17, wherein resulting energy penetration through said composition is about 50 nanoJoules or less when said composition is subjected to an ESD event of about 1000 volts.

20. A storage container having electrostatic shielding properties, said storage container comprising:
a paper component having a basis weight of about 10 lbs/MSF to about 69 lbs/MSF;
an electrostatic shielding layer deposited on said paper component;
said storage container has a surface resistance of less than about 1.0×10³ ohms; and
said electrostatic shielding layer comprising at least one coat of conductive ink and at least one coat of varnish over said coat of conductive ink.

21. The storage container of claim 20, further comprising:
at least one additional coat of water-based ink between said conductive ink and said varnish, said additional coat of water-based ink provides a visually identifiable mark.

22. The storage container of claim 20, wherein said storage container has a surface resistance of less than about 5.0×10² ohms.

23. The storage container of claim 20, wherein said storage container has a surface resistance of less than about 4.1×10² ohms.

24. The storage container of claim 20, wherein resulting voltage penetration of said storage container is about 100 volts or less when said storage container is subjected to an ESD event of about 3,500 volts.

25. The storage container of claim 20, wherein resulting energy penetration of said storage container about 50 nanoJoules or less when said storage container is subjected to an ESD event of about 1000 volts.

26. The storage container of claim 20, wherein resulting voltage penetration of said storage container is about 100 volts or less when said storage container is subjected to an ESD event of about 1000 volts.

27. The storage container of claim 20, wherein resulting voltage penetration of said storage container is about 50 volts or less when said storage container is subjected to an ESD event of about 1000 volts.

28. The storage container of claim 20, wherein resulting energy penetration of said storage container is about 50 nanoJoules or less when said storage container is subjected to an ESD event of about 1000 volts under conditions of about 12% relative humidity.

29. The storage container of claim 20, wherein said conductive ink is a water-based ink comprising a conductive material selected from the group consisting of carbon black, graphite and conductive polymers.

30. The storage container of claim 20, wherein the paper has a basis weight of from about 26 lbs/MSF to about 36 lbs/MSF.

31. The storage container of claim 20, wherein said electrostatic shielding layer comprises a conductive material in an amount ranging from about 0.5 lbs per MSF of said paper component to about 3.5 lbs per MSF of said paper component said conductive material being selected from the group consisting of carbon black, graphite and conductive polymers.

32. A storage container having electrostatic shielding properties, said storage container comprising:
a paper component having a basis weight of about 10 lbs/MSF to about 69 lbs/MSF;
an electrostatic shielding layer deposited on said paper component;
said electrostatic shielding layer comprising at least one coat of conductive ink, at least one additional coat of ink, said additional coat of ink provides a visually identifiable mark within said electrostatic shielding layer and at least one coat of varnish;
said storage container has a surface resistance of less than about 1.0×10³ ohms; and,
wherein the resulting voltage penetration through said storage container is about 100 volts or less when said storage container is subjected to a voltage discharge of about 3,500 volts.

33. The storage container of claim 32, wherein said electrostatic shielding layer comprises at least two coats of conductive ink and said conductive ink is a water-based ink comprising a conductive material selected from the group consisting of carbon black, graphite and conductive polymers.

34. The storage container of claim 32, wherein said electrostatic shielding layer comprises a conductive material in an amount ranging from about 0.5 lbs per MSF of said paper component to about 3.5 lbs per MSF of said paper component said conductive material being selected from the group consisting of carbon black, graphite and conductive polymers.

35. A storage container having electrostatic shielding properties, said storage container comprising:
a paper component having a basis weight of about 10 lbs/MSF to about 69 lbs/MSF;
an electrostatic shielding layer deposited on said paper component;
said electrostatic shielding layer comprising at least one coat of conductive ink, at least one additional coat of ink over at least a portion of said coat of conductive ink, said additional coat of ink provides a visually identifiable mark and at least one coat of varnish, wherein said electrostatic shielding layer comprises a conductive material in an amount ranging from about 0.5 lbs per MSF of said paper component to about 3.5 lbs per MSF of said paper component said conductive material being selected from the group consisting of carbon black, graphite and conductive polymers;
said storage container has a surface resistance of less than about 1.0×10³ ohms; and,
wherein resulting voltage penetration through said storage container is about 50 nanoJoules or less when said storage container is subjected to an ESD event of about 1000 volts.

36. The storage container of claim 35, wherein said electrostatic shielding layer comprises at least two coats of conductive ink and said conductive ink is a water-based ink comprising a conductive material selected from the group consisting of carbon black, graphite, diacetone acrylamide diallydimethylammonium chloride copolymer, polyethylene glycol, diethanol amide, polypyrroles, and poly(3,4-ethylenedioxythiophene)-poly(styrenesulfonate).

37. A method for protecting ESD-sensitive components from ESD comprising the steps of:
forming an electrostatic shielding packaging composition by applying an electrostatic shielding layer to a paper component, said electrostatic shielding layer comprising at least one coat of a water-based conductive ink and at least one coat of varnish;
said paper component having a basis weight between about 10 lbs/MSF to about 69 lbs/MSF; and
placing said electrostatic shielding packaging composition around said ESD-sensitive device such that the electrostatic shielding layer faces said ESD-sensitive device.

38. The method of claim 37, wherein said electrostatic shielding layer further comprises at least one additional coat of a water-based ink, said additional coat of water-based ink provides a visually identifiable mark within said electrostatic shielding layer.

39. The method of claim 37, further comprising the step of applying said conductive ink by means of a printing process selected from the group consisting of preprinting, line screening, gravure printing and off-set printing.

40. The method of claim 37, further comprising the step of applying said coat of conductive water-based ink and varnish to said paper component at a rate of about 6400 to about 90,000 dots per square inch by a preprint process.

41. The method of claim 37, wherein said water-based conductive ink comprises a conductive material selected from the group consisting of carbon black, graphite and conductive polymers.

42. The method of claim 41, where said conductive polymers are selected from the group consisting of diacetone acrylamide diallydimethylammonium chloride copolymer, polyethylene glycol, diethanol amide, polypyrroles, and poly(3,4-ethylenedioxythiophene)-poly(styrenesulfonate).

43. The method of claim 37, wherein said conductive material comprises from about 12% to about 30% by weight of said water-based conductive ink.

44. The method of claim 37, wherein said electrostatic shielding layer comprises from about 1.5 pounds of conductive material per MSF of said paper component to about 3.5 pounds of conductive material per MSF of said paper component.

45. The method of claim 37, wherein said electrostatic shielding layer comprises about 0.5 pounds of conductive material per MSF of said paper component to about 2 pounds of conductive material per MSF of said paper component.

46. The method of claim 37, further comprising a step of securing said composition about said ESD-sensitive device by means of a charge generator.

47. The method of clam 37, further comprising the step of forming said composition into a container and placing said ESD-sensitive device in said container.

48. The method of claim 37, wherein said electrostatic shielding layer comprises at least two coats of conductive ink.

49. The method of claim 37, wherein sufficient conductive ink is applied to provide a surface resistance of less than about 1.0×10³ ohms.

50. The method of claim 37, wherein resulting voltage penetration of said electrostatic shielding packaging composition is about 100 volts or less when subjected to an ESD of about 3,500 volts.

51. The method of claim 37, wherein resulting energy penetration of said electrostatic shielding packaging composition is about 50 nanoJoules or less when said composition is subjected to an ESD event of about 3,500 volts.

52. The method of claim 37, wherein resulting energy penetration of said electrostatic shielding packaging composition is about 50 nanoJoules or less when said composition is subjected to an ESD event of about 1000 volts.

53. The method of claim 37, wherein said paper component has a basis weight of from about 26 lbs. per MSF to about 36 lbs. per MSF.

54. A method for applying a visually identifiable mark to an electrostatic shielding packaging composition comprising the steps:
providing a paper component having a basis weight of from about 10 lbs/MSF to about 69 lbs/MSF;
applying at least one coat of conductive ink to the first side of said paper component;
applying a coat of water-based ink, providing a visually identifiable mark; and
applying at least one coat of varnish.

55. The method of claim 54, wherein said conductive ink, said water based ink and said varnish are applied to said paper component by a preprint process.

56. The method of claim 54, wherein said conductive ink is applied at a rate of about 6400 to about 90,000 dots per square inch.

57. The method of claim 54, wherein said conductive ink is applied in sufficient quantity to provide a surface resistance of less than about 1.0×10³ ohms.

58. The method of claim 54, wherein resulting voltage penetration of said electrostatic shielding packaging composition is about 100 volts or less when subjected to an ESD event of about 3,500 volts.

59. The method of claim 54, wherein resulting energy penetration of said electrostatic shielding packaging composition about 50 nanoJoules or less when said composition is subjected to an ESD event of about 3,500 volts.

60. The method of claim 54, wherein resulting energy penetration of said electrostatic shielding packaging composition is about 50 nanoJoules or less when said composition is subjected to an ESD event of about 1000 volts.

61. The method of claim 54, wherein said water-based ink providing said visually identifiable mark is applied at a line screen rate of about 50 to about 85.

62. The method of claim 54, wherein said conductive ink comprises a conductive material selected from the group consisting of carbon black, graphite and conductive polymers and wherein sufficient conductive ink is applied to yield an electrostatic shielding packaging composition comprising from about 0.5 lbs. of conductive material per MSF of paper component to about 3.5 lbs. of conductive material per MSF of said paper component.
